(19) United States
(12) Patent Application Publication
(10) Pub. No.: US 2026/0190093 A1
(43) Pub. Date: Jul. 2, 2026

(54) WIRELESS COMMUNICATION METHOD AND COMMUNICATIONS DEVICE

(71) Applicant: QUECTEL WIRELESS SOLUTIONS CO., LTD., Shanghai (CN)

(72) Inventor: Zheng ZHAO, Shanghai (CN)

(21) Appl. No.: 19/444,280

(22) Filed: Jan. 9, 2026

Related U.S. Application Data
(63) Continuation of application No. PCT/CN2024/144449, filed on Dec. 31, 2024.

(51) Int. Cl. H04W 72/0446; H04L 5/00; H04L 27/26

(52) U.S. Cl. CPC H04W 72/0446; H04L 5/0007; H04L 27/2678

(57) ABSTRACT

Disclosed are a wireless communication method and a communications device. One example method includes: transmitting sensing signals on a plurality of consecutive time domain symbols, wherein the plurality of time domain symbols comprise a first time domain symbol and N second time domain symbols located after the first time domain symbol, a signal in the second time domain symbol comprises the sensing signal, and at least one of a cyclic prefix determined based on the sensing signal or a cyclic postfix determined based on the sensing signal, signals in the plurality of time domain symbols are periodic and have a period equal to a length of the sensing signal in each time domain symbol, and N is a positive integer.

### CROSS-REFERENCE TO RELATED APPLICATIONS

This application is a continuation of International Application No. PCT/CN2024/144449, filed on December 31, 2024, the disclosure of which is hereby incorporated by reference in its entirety.

### TECHNICAL FIELD

The present application relates to the field of communications technologies, and more specifically, to a wireless communication method and a communications device.

### BACKGROUND

In wireless sensing technologies, information such as a location, a motion state, and a physiological characteristic of an object are detected and identified by analyzing an interaction relationship between wireless signals and the object. When sensing (sensing) signals and communication signals coexist in a system, hardware and resources may be shared between the sensing signals and the communication signals. Therefore, how to effectively transmit sensing signals in a communications system has become a problem that needs to be resolved.

### SUMMARY

The present application provides a wireless communication method and a communications device. Various aspects used in the present application are described below.

According to a first aspect, a wireless communication method is provided. The method includes: transmitting sensing signals on a plurality of consecutive time domain symbols, where the plurality of time domain symbols include a first time domain symbol and N second time domain symbols located after the first time domain symbol, a signal in the second time domain symbol includes the sensing signal, and a cyclic prefix and/or a cyclic postfix determined based on the sensing signal, signals in the plurality of time domain symbols are periodic and have a period equal to a length of the sensing signal in each time domain symbol, and N is a positive integer.

According to a second aspect, a wireless communication method is provided. The method includes: receiving sensing signals transmitted on a plurality of consecutive time domain symbols, where the plurality of time domain symbols include a first time domain symbol and N second time domain symbols located after the first time domain symbol, a signal in the second time domain symbol includes the sensing signal, and a cyclic prefix and/or a cyclic postfix determined based on the sensing signal, signals in the plurality of time domain symbols are periodic and have a period equal to a length of the sensing signal in each time domain symbol, and N is a positive integer.

According to a third aspect, a communications device is provided. The communications device includes: a transceiver unit, transmitting sensing signals on a plurality of consecutive time domain symbols, where the plurality of time domain symbols include a first time domain symbol and N second time domain symbols located after the first time domain symbol, a signal in the second time domain symbol includes the sensing signal, and a cyclic prefix and/or a cyclic postfix determined based on the sensing signal, signals in the plurality of time domain symbols are periodic and have a period equal to a length of the sensing signal in each time domain symbol, and N is a positive integer.

According to a fourth aspect, a communications device is provided. The communications device includes: a transceiver unit, receiving sensing signals transmitted on a plurality of consecutive time domain symbols, where the plurality of time domain symbols include a first time domain symbol and N second time domain symbols located after the first time domain symbol, a signal in the second time domain symbol includes the sensing signal, and a cyclic prefix and/or a cyclic postfix determined based on the sensing signal, signals in the plurality of time domain symbols are periodic and have a period equal to a length of the sensing signal in each time domain symbol, and N is a positive integer.

According to a fifth aspect, a communications device is provided, including a transceiver, a memory, and a processor. The memory is configured to store a program. The processor is configured to invoke the program in the memory, and control the transceiver to receive or transmit a signal, to cause the communications device to perform the method according to the first aspect.

According to a sixth aspect, a communications device is provided, including a transceiver, a memory, and a processor. The memory is configured to store a program. The processor is configured to invoke the program in the memory, and control the transceiver to receive or transmit a signal, to cause the communications device to perform the method according to the second aspect.

According to a seventh aspect, an apparatus is provided, including a processor, invoking a program from a memory, to cause the apparatus to perform the method according to the first aspect or the second aspect.

According to an eighth aspect, a chip is provided, including a processor, invoking a program from a memory, to cause a device installed with the chip to perform the method according to the first aspect or the second aspect.

According to a ninth aspect, a computer-readable storage medium is provided, where a program is stored on the computer-readable storage medium, and the program causes a computer to perform the method according to the first aspect or the second aspect.

According to a tenth aspect, a computer program product is provided, where the computer program product includes a program, and the program causes a computer to perform the method according to the first aspect or the second aspect.

According to an eleventh aspect, a computer program is provided, where the computer program causes a computer to perform the method according to the first aspect or the second aspect.

In embodiments of the present application, the sensing signals are transmitted on the plurality of consecutive time domain symbols, where the plurality of time domain symbols include the first time domain symbol and the N second time domain symbols located after the first time domain symbol, and the signal in each of the second time domain symbols includes the sensing signal, and the cyclic prefix and/or the cyclic postfix determined based on the sensing signal. Design of a cyclic prefix and/or a cyclic postfix makes it possible that the signals in the plurality of time domain symbols are periodic and have a period equal to the length of the sensing signal in each time domain symbol. In this way, continuous transmission of the sensing signal is achieved and a periodicity of the sensing signal is ensured.

### BRIEF DESCRIPTION OF THE DRAWINGS

FIG. 1 is an example diagram of a system architecture of a wireless communications system applicable to embodiments of the present application.

FIG. 2 is a schematic diagram of an implementation process of OFDM.

FIG. 3 is a schematic diagram of adding a conventional CP to a sensing signal.

FIG. 4 is a schematic flowchart of a wireless communication method according to an embodiment of the present application.

FIG. 5 is a schematic diagram of adding head and tail CPs to two adjacent time domain symbols respectively according to an embodiment of the present application.

FIG. 6 is a schematic diagram of an OFDM implementation process in which a sensing signal and a communication signal with alternating head and tail CPs coexist according to an embodiment of the present application.

FIG. 7 is a schematic diagram of an OFDM implementation process in which a sensing signal and a communication signal based on cyclic shift CPs coexist according to an embodiment of the present application.

FIG. 8 is a schematic structural diagram of a communications device according to an embodiment of the present application.

FIG. 9 is a schematic structural diagram of a communications device according to an embodiment of the present application.

FIG. 10 is a schematic diagram of an apparatus for communication according to an embodiment of the present application.

### DETAILED DESCRIPTION OF THE EMBODIMENTS

The technical solutions in the present application are described below with reference to the accompanying drawings.

### Wireless communications system

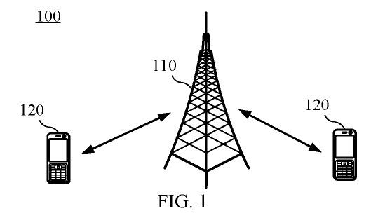

FIG. 1 is an example diagram of a system architecture of a wireless communications system 100 to which an embodiment of the present application is applicable. The wireless communications system 100 may include a network device 110 and a terminal device 120. The network device 110 may be a device that communicates with the terminal device 120. The network device 110 may provide communication coverage for a specific geographical area, and may communicate with the terminal device 120 located within the coverage. The terminal device 120 may access a network, for example, a wireless network, by using the network device 110. Optionally, the wireless communications system 100 may further include other network entities such as a network controller and a mobility management entity, which is not limited in embodiments of the present application.

It should be understood that the technical solutions of embodiments of the present application may be applied to various communications systems, such as a 5^{th} generation (fifth generation, 5G) system or a new radio (new radio, NR) system, a long term evolution (long term evolution, LTE) system, an LTE frequency division duplex (frequency division duplex,

FDD) system, and an LTE time division duplex (time division duplex, TDD) system. The technical solutions provided in the present application may further be applied to a future communications system, such as a 6th generation mobile communications system or a satellite communications system.

The terminal device in embodiments of the present application may alternatively be referred to as a user equipment (user equipment, UE), an access terminal, a subscriber unit, a subscriber station, a mobile site, a mobile station (mobile station, MS), a mobile terminal (mobile terminal, MT), a remote station, a remote terminal, a mobile device, a user terminal, a terminal, a wireless communications device, a user agent, or a user apparatus. The terminal device in embodiments of the present application may be a device providing a user with voice and/or data connectivity and capable of connecting people, objects, and machines, such as a handheld device or a vehicle-mounted device having a wireless connection function. The terminal device may alternatively be a mobile phone (mobile phone), a tablet computer (Pad), a notebook computer, a palmtop computer, a mobile Internet device (mobile internet device, MID), a wearable device, a virtual reality (virtual reality, VR) device, an augmented reality (augmented reality, AR) device, a wireless terminal in industrial control (industrial control), a wireless terminal in self driving (self driving), a wireless terminal in remote medical surgery (remote medical surgery), a wireless terminal in a smart grid (smart grid), a wireless terminal in transportation safety (transportation safety), a wireless terminal in a smart city (smart city), a wireless terminal in a smart home (smart home), or the like. Optionally, the terminal device may be used to act as a base station. For example, the terminal device may function as a scheduling entity that provides a sidelink signal between terminal devices in vehicle-to-everything (vehicle to everything, V2X), device-to-device (device to device, D2D), or the like. For example, a cellular phone and a vehicle communicate with each other by using a sidelink signal. A cellular phone and a smart household device communicate with each other, without the relay of a communication signal through a base station.

The network device in embodiments of the present application may be a device configured to communicate with the terminal device. The network device may be an access network device or a wireless access network device. For example, the network device may be a base station. The base station may broadly cover the following various names, or may be replaced with the following names: a NodeB (NodeB), an evolved NodeB (evolved NodeB, eNB), a next generation NodeB (next generation NodeB, gNB), a relay station, a transmitting and receiving point (transmitting and receiving point, TRP), a transmitting point (transmitting point, TP), a master eNodeB (MeNB), a secondary eNodeB (SeNB), a multi-standard radio

(MSR) node, a home base station, a network controller, an access node, a wireless node, an access point (access point, AP), a transmission node, a transceiver node, a baseband unit (baseband unit, BBU), a remote radio unit (remote radio unit, RRU), an active antenna unit (active antenna unit, AAU), a remote radio head (remote radio head, RRH), a central unit (central unit, CU), a distributed unit (distributed unit, DU), a positioning node, and the like. The base station may be a macro base station, a micro base station, a relay node, a donor node, or the like, or a combination thereof. Alternatively, the base station may be a communications module, a modem, or a chip disposed in the device or the apparatus described above. Alternatively, the base station may be a mobile switching center, a device that functions as a base station in device-to-device D2D, vehicle-to-everything (vehicle-to-everything, V2X), and machine-to-machine (machine-to-machine, M2M) communications, a network-side device in a 6G network, a device that functions as a base station in a future communications system, or the like. The base station may support networks of a same access technology or different access technologies. A specific technology and a specific device form used by the network device are not limited in embodiments of the present application. The base station may support networks of a same access technology or different access technologies. A specific technology and a specific device form used by the network device are not limited in embodiments of the present application.

In addition, the base station may be fixed or mobile. For example, a helicopter or an unmanned aerial vehicle may be configured to function as a mobile base station, and one or more cells may move according to a location of the mobile base station. In other examples, a helicopter or an unmanned aerial vehicle may be configured to function as a device in communication with another base station.

The network device and the terminal device may be deployed on land, including being indoors or outdoors, handheld, or vehicle-mounted, may be deployed on a water surface, or may be deployed on a plane, a balloon, or a satellite in the air. In embodiments of the present application, a scenario of the network device and the terminal device is not limited.

It should be understood that all or some of functions of the communications device in the present application may also be implemented by software functions running on hardware, or by virtualization functions instantiated on a platform (for example, a cloud platform).

As an independently developed technology, wireless sensing has no obvious intersection with development of mobile communications systems. Sensing services are provided by various specialized sensing devices, such as a conventional radar, a lidar, computed tomography, and magnetic resonance imaging. In 5G and earlier communications systems, positioning is an earliest sensing service that mobile communications systems can provide.

Future mobile communications systems transcend interconnection of people and things, and move towards a new era of intelligent interconnection of everything. For example, the future mobile communications systems may include six major application scenarios, three of the scenarios are enhanced communication scenarios based on the 5G system, and the other three scenarios are newly introduced scenarios transcending communication and include integrated sensing and communication (integrated sensing and communication, ISAC). Therefore, the future communications systems have characteristics such as a full frequency band, a large bandwidth, massive antenna arrays, and multi-node collaboration. It is precisely because the future communications systems have such characteristics that ISAC may be implemented in the same system, and communication and sensing functions complement each other.

In a 6G system, general sensing services rather than positioning may be integrated into a communications system as a brand new function, to open up brand new services. ISAC may help mobile operators provide many new services, such as high-accuracy localization, tracking, biomedical and security imaging, simultaneous localization and mapping used to construct maps for complex indoor and outdoor environments, pollution and natural disaster monitoring, gesture and activity recognition, and flaw and material detection. These new services may in turn create new business scenarios for future consumers and vertical industries. The ISAC system may support new services, and application scenarios of different industries (for example, vertical industries, consumers, and public services) are divided into the following four categories according to functions: high-accuracy localization and tracking, simultaneous imaging, mapping, and localization, augmented human sensing, and gesture and activity recognition.

In addition to providing the new services and new businesses, sensing may further assist in communication and positioning. Sub-centimeter level positioning solutions are required in the 6G system to meet various types of application scenarios in the future. This level of positioning accuracy requires more detailed knowledge of a propagation environment of wireless signals. By obtaining a radio frequency map of the propagation environment, a location of a corresponding terminal device may be obtained. In this way, multipath characteristics of a propagation channel may be helpful. High-frequency band channels are sparser, a quantity of main reflection paths is smaller, and mapping between the location of the terminal device and a propagation channel of the terminal device is easier, which is more conducive to this type of sensing-assisted positioning.

For the ISAC scenario, in one aspect, the entire communication network may be used as a huge sensor. Network elements transmit and receive wireless signals, and use transmission, reflection, and scattering of radio waves to better sense and understand the physical world. Information such as a distance, a velocity, or an angle is obtained from wireless signals, so that a wide range of new services such as high-accuracy localization, gesture capturing, activity recognition, passive object detection and tracking, and imaging and environment reconstruction may be provided, to implement “network as a sensor (network as a sensor)”, and capabilities such as ultra-high-resolution detection, positioning, and tracking, environmental target reconstruction and imaging, and target activity recognition can be provided, to implement network service scenarios such as smart homes, smart factories, smart medical care, and ultimate autonomous driving. In another aspect, the capabilities of high-accuracy localization, and imaging and environment reconstruction offered by sensing may help improve communication performance, for example, more accurate beamforming, faster beam failure recovery, and less overheads when tracking terminal channel state information (channel state information, CSI), thereby implementing “sensing-assisted communication”. Moreover, sensing is also a “new channel” that observes and samples the physical and biological worlds, and links the physical and biological worlds to a digital world. For this reason, real-time network sensing can replicate a parallel digital world for the physical world, and this is extremely important for implementing a concept of a “digital twin” in the future. As a strategic emerging industry, low-altitude economy is playing an increasingly important role in promoting economic development and strengthening social security. Therefore, future communication networks need to provide more three-dimensional coverage for communication and sensing.

When sensing and communication coexist in a same system, sensing signals and communication signals may share hardware and resources (for example, spectrum resources). Hardware sharing may effectively reduce costs, simplify deployment, and reduce maintenance issues, thereby allowing sensing to benefit from economies of scale of mobile communication networks; and spectrum sharing makes spectrum utilization more efficient than using independent spectrums individually. Further, from the perspective of waveforms and signal processing, time domain waveforms, frequency domain waveforms, and spatial domain waveforms and signal processing techniques may be combined to serve both sensing and communication functions. Furthermore, communication and sensing information may be shared across layers, modules, and nodes, and communication and sensing are fully integrated, which significantly improves system performance, greatly reduces the overall costs and power consumption of the network system, and makes the system smaller in scale. Processing capabilities of sensing data may be further improved by other technology innovations such as a larger scale of collaboration between base stations and terminal devices, joint design of communication and sensing waveforms, advanced techniques for interference cancellation, and a native artificial intelligence (artificial intelligence, AI) technology.

Embodiments of the present application relate to design of a communications system in which communication and sensing coexist, a core of the design is signal joint design, where there are differences between sensing signals and communication signals. Design of the communication signals focuses on improving spectral efficiency, while design of the sensing signals focuses on improving sensing resolution and accuracy. Therefore, it is required to perform underlying signal design based on requirements of the communication signals and the sensing signals, to seek a performance balance between the communication signals and the sensing signals. A cyclic prefix-orthogonal frequency division multiplexing (cyclic prefix-orthogonal frequency division multiplexing, CP-OFDM) waveform is suitable for transmission of communication signals. In some studies, the CP-OFDM waveform is also considered to be applied to sensing signals.

Although a cyclic prefix (cyclic prefix, CP) affects autocorrelation, a frequency domain processing method can not only be used to efficiently estimate CP-OFDM–based parameters, but also be used to maximize a processing gain. Therefore, coexistence of communication signals and sensing signals may be implemented based on the OFDM waveform. For example, a communication signal and a sensing signal may share an OFDM symbol, that is, a same OFDM symbol may be used to transmit both the communication signal and the sensing signal. In this case, in order to ensure performance of the sensing signal, the sensing signal needs to be continuously transmitted on a plurality of OFDM symbols, that is, the sensing signal may span a duration of adjacent OFDM symbols.

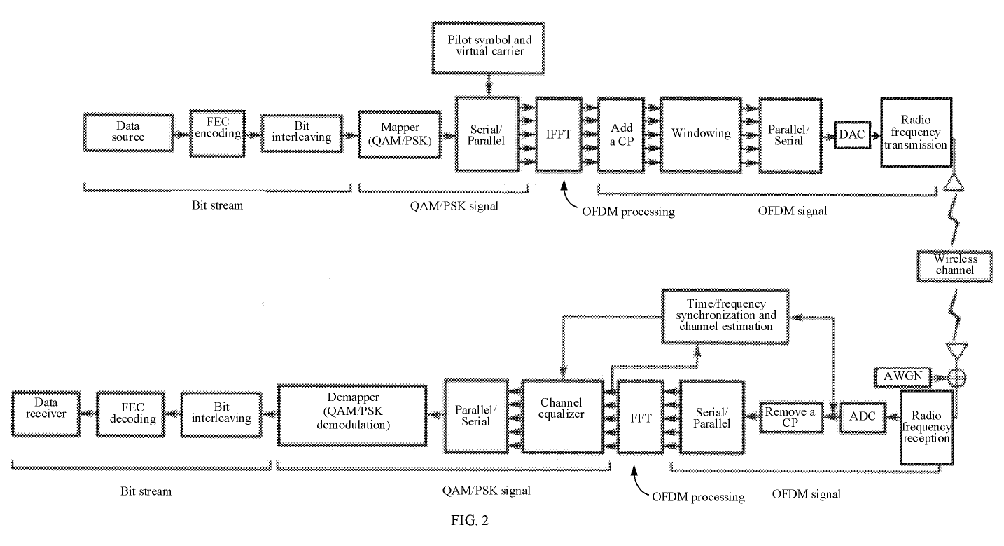

As an example, FIG. 2 shows an implementation process of OFDM. A signal processing flow in an upper row corresponds to a transmit end, and a signal processing flow in a lower row corresponds to a receive end. OFDM processing at the transmit end includes performing inverse fast flourier transform (inverse fast flourier transform, IFFT) on a signal obtained after mapping and serial-to-parallel conversion. Then, after operations such as adding a CP, windowing, parallel-to-serial conversion, and digital-to-analog conversion (digital-to-analog converter, DAC), a to-be-sent radio frequency signal may be formed. Similarly, the receive end performs a corresponding inverse operation on the received radio frequency signal to obtain actual data content carried in the signal. For example, for OFDM processing at the receive end, an operation such as fast Fourier transform (FFT) needs to be performed on the OFDM signal. When the communication signals and the sensing signals coexist, for example, at the transmit end, the communication signals and the sensing signals may be loaded at an input end of the IFFT. After the IFFT, at an output end of the IFFT, each tap has a signal that is obtained after mixing a communication signal and a sensing signal. It may be impossible to add CPs to the communication signal and the sensing signal respectively after the mixing.

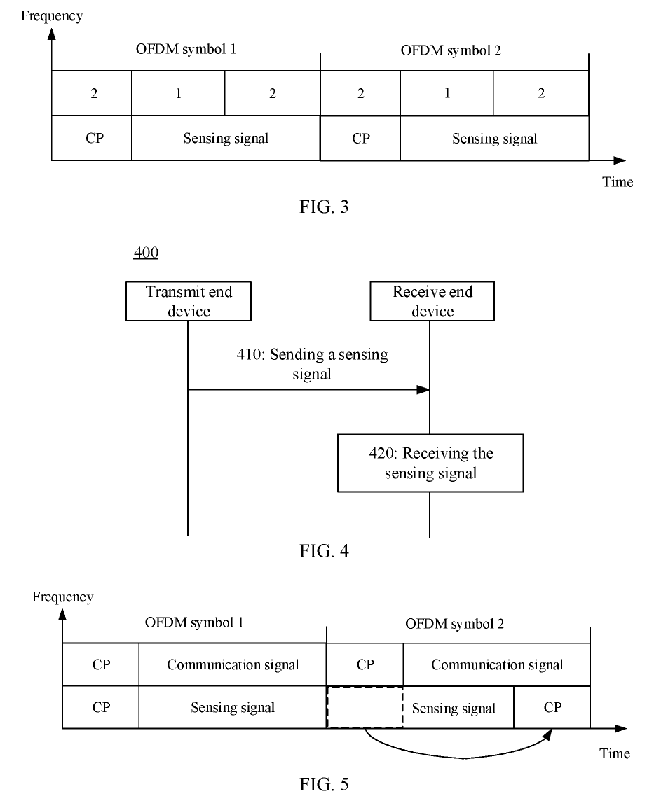

If a CP is added to the sensing signal in the same manner as a CP adding manner in OFDM, a time domain periodicity of a sensing signal sequence cannot be ensured, and therefore, a good autocorrelation cannot be obtained. For example, as shown in FIG. 3, it is assumed that a complete sequence of a sensing signal is (1, 2), after a CP is added to the sequence (1, 2) in each of an OFDM symbol 1 and an OFDM symbol 2, the sequence becomes (2, 1, 2) in each of the OFDM symbol 1 and the OFDM symbol 2, that is, a signal transmitted in the OFDM symbol 1 and the OFDM symbol 2 is (2, 1, 2, 2, 1, 2). This significantly changes the sequence of the sensing signal, and the sensing signal cannot be transmitted periodically.

Therefore, in embodiments of the present application, sensing signals are transmitted on a plurality of consecutive time domain symbols, where the plurality of time domain symbols include a first time domain symbol and N second time domain symbols located after the first time domain symbol, and a signal in each of the second time domain symbols includes the sensing signal, and a cyclic prefix and/or a cyclic postfix determined based on the sensing signal. Design of a cyclic prefix and/or a cyclic postfix makes it possible that signals in the plurality of time domain symbols are periodic and have a period equal to a length of the sensing signal in each time domain symbol. In this way, continuous transmission of the sensing signal is achieved and a periodicity of the sensing signal is ensured.

The following describes the embodiment of the present application in detail with reference to FIG. 4.

FIG. 4 is a schematic flowchart of a wireless communication method according to an embodiment of the present application. The method 400 shown in FIG. 4 may be performed by a transmit end and a receive end. The transmit end and the receive end are communications devices, for example, the transmit end is a terminal device and the receive end is a network device; or the receive end is a terminal device and the transmit end is a network device. The terminal device may be, for example, the terminal device 120 shown in FIG. 1, and the network device may be, for example, the network device 110 shown in FIG. 1.

Referring to FIG. 4, in Step 410, the transmit end transmits sensing signals on a plurality of consecutive time domain symbols.

Correspondingly, in Step 420, the receive end receives the sensing signals transmitted on the plurality of consecutive time domain symbols.

The time domain symbol may be, for example, the foregoing OFDM symbol or another type of time domain symbol obtained based on the OFDM symbol.

The plurality of time domain symbols include a first time domain symbol and N second time domain symbols located after the first time domain symbol, where N is a positive integer. A signal in the second time domain symbol may include the sensing signal, and a cyclic prefix and/or a cyclic postfix (CPost) determined based on the sensing signal. Signals in the plurality of time domain symbols are periodic and have a period equal to a length of the sensing signal in one time domain symbol.

For example, the cyclic prefix may be formed by copying a tail signal of the sensing signal to a head of the sensing signal. For example, the cyclic postfix may be formed by copying a header signal of the sensing signal to a tail of the sensing signal. The cyclic postfix may also be referred to as a cyclic prefix at a trail.

Embodiments of the present application are applicable to a scenario in which sensing signals and communication signals coexist in a same system. To this end, different processing manners may be used for communication signals and sensing signals. The communication signal and the sensing signal may be transmitted in a same OFDM symbol, for example, the communication signal and the sensing signal may be transmitted through different subcarriers in the same OFDM symbol.

First, for the first time domain symbol, in some implementations, the first time domain symbol may include the sensing signal and the cyclic prefix that is determined based on the sensing signal in the first time domain symbol.

Second, for the second time domain symbol, in some implementations, the second time domain symbol may include the sensing signal and the cyclic postfix that is determined based on the sensing signal in the second time domain symbol. In other implementations, the second time domain symbol may include the cyclically shifted sensing signal and the cyclic prefix that is determined based on the cyclically shifted sensing signal.

The plurality of time domain symbols used for continuously transmitting the sensing signals include the first time domain symbol and the N second time domain symbols located after the first time domain symbol. When N = 1, the first time domain symbol and the second time domain symbol may be considered as two adjacent time domain symbols in the plurality of time domain symbols for transmitting the sensing signals, that is, the plurality of time domain symbols for transmitting the sensing signals may include a plurality of groups of “first time domain symbol and second time domain symbols”. As an example, four time domain symbols are used as an example, the consecutive time domain symbols for the sensing signals include a time domain symbol 1, a time domain symbol 2, a time domain symbol 3, and a time domain symbol 4, where the time domain symbol 1 and the time domain symbol 3 are first time domain symbols, and the time domain symbol 2 and the time domain symbol 4 are second time domain symbols. In the following, only a group of “first time domain symbol and second time domain symbols” is used as an example for description.

When N > 1, the first time domain symbol may be considered as a start time domain symbol of the sensing signal. That is, the sensing signals are transmitted through consecutive N+1 time domain symbols (that is, one first time domain symbol and N second time domain symbols).

In the following, two implementations of the second time domain symbol are described respectively.

### Implementation 1

In this implementation, when N = 1, the signal in the second time domain symbol may include the sensing signal and the cyclic postfix that is determined based on the sensing signal. For example, the time domain symbols for continuously transmitting the sensing signals include the first time domain symbol and the second time domain symbol located after the first time domain symbol, where the signal in the first time domain symbol includes the sensing signal and the cyclic prefix that is determined based on the sensing signal, and the second time domain symbol includes the sensing signal and the cyclic postfix that is determined based on the sensing signal.

When scheduling resources for a user having communication needs and sensing needs, a network device may perform frequency division scheduling like in LTE and NR systems, and there is no need to allocate separate resource pools for communication signals and sensing signals, which can reduce scheduling complexity and increase resource utilization to achieve compatibility with conventional terminal devices. As an example, as shown in FIG. 5, when sensing signals and communication signals are multiplexed in OFDM symbols, the sensing signals and the communication signals may be multiplexed in frequency domain, and share a set of subcarriers, and allocation of subcarriers may be continuous or discontinuous. In time domain, the sensing signals are repeated between two adjacent symbols (that is, the OFDM symbol 1 and the OFDM symbol 2). A CP is set before the communication signal in the OFDM symbol 1, and a CP is set before the sensing signal in the OFDM symbol 1. A CP is set before the communication signal in the OFDM symbol 2, and a cyclic postfix is set after the sensing signal in the OFDM symbol 2. That is, the sensing signals alternately use the cyclic prefix and the cyclic postfix between the OFDM symbols.

For example, it is assumed that the sensing signal includes a sequence (1, 2), a tail of the sequence (1, 2) is added to a head of the OFDM symbol 1 as a cyclic prefix, to obtain a sequence in the OFDM symbol 1 that is (2, 1, 2), and a head of the sequence (1, 2) is added to a tail of the OFDM symbol 2 as a cyclic postfix, to obtain a sequence in the OFDM symbol 2 that is (1, 2, 1). In this way, a signal transmitted on the OFDM symbol 1 and the OFDM symbol 2 includes (2, 1, 2, 1, 2, 1). The sequence is periodic and has a period equal to a length of the sequence (2, 1).

For another example, it is assumed that the sensing signal includes a sequence (1, 2, 3, 4), a tail of the sequence (1, 2, 3, 4) is added to a head of the OFDM symbol 1 as a cyclic prefix, to obtain a sequence in the OFDM symbol 1 that is (3, 4, 1, 2, 3, 4), and a head of the sequence (1, 2, 3, 4) is added to a tail of the OFDM symbol 2 as a cyclic postfix, to obtain a sequence in the OFDM symbol 2 that is (1, 2, 3, 4, 1, 2). In this way, a signal transmitted on the OFDM symbol 1 and the OFDM symbol 2 includes (3, 4, 1, 2, 3, 4, 1, 2, 3, 4, 1, 2). The sequence is periodic and has a period equal to a length of the sequence (3, 4, 1, 2).

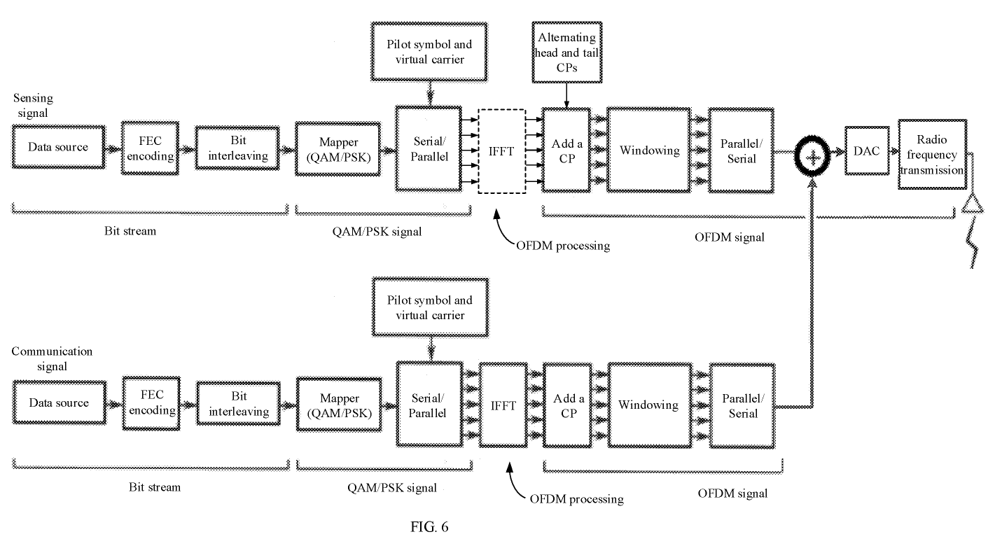

As an example, FIG. 6 shows an OFDM procedure corresponding to Implementation 1, where in the step of adding the cyclic prefix, different processing manners are used for the communication signals and the sensing signals. On a branch corresponding to the sensing signal shown in FIG. 6, it is required to alternately add a cyclic prefix and a cyclic postfix to the sensing signals in two adjacent symbols. For example, a cyclic prefix and a cyclic postfix are added respectively for two OFDM symbols for repeatedly transmitting the sensing signals, a cyclic prefix is added to the first OFDM symbol in the two OFDM symbols, and a cyclic postfix is added to the second OFDM symbol in the two OFDM symbols. On a branch corresponding to the communication signal shown in FIG. 6, a cyclic prefix may be added in a conventional manner. Finally, the communication signal and the sensing signal may be transmitted simultaneously on the same OFDM symbol, for example, the sensing signal and the communication signal may be transmitted on different subcarriers in the same OFDM signal.

### Implementation 2

In this implementation, when N > 1, the signal in the second time domain symbol includes the cyclically shifted sensing signal and the cyclic prefix that is determined based on the cyclically shifted sensing signal. For example, the plurality of time domain symbols for continuously transmitting the sensing signals include the first time domain symbol and the N second time domain symbols located after the first time domain symbol, where the signal in the first time domain symbol includes the sensing signal and the cyclic prefix that is determined based on the sensing signal, and each of the N second time domain symbols includes the sensing signal in each second time domain symbol and the cyclic postfix that is determined based on the sensing signal. That is, for the plurality of time domain symbols for repeatedly transmitting the sensing signals, it is required to cyclically shift (or shift) the sensing signal in each second time domain symbol located after the first time domain symbol, and then add a cyclic prefix.

In some implementations, a cyclic shift value corresponding to an n^{th} second time domain symbol in the N second time domain symbols is n*I_{CP}, I_{CP} is a length of the cyclic prefix (for example, a length of a cyclic prefix of the first time domain symbol), and n ranges from 1 to N. For example, when n = 1, a cyclic shift value corresponding to the 1^{st} second time domain symbol in the N second time domain symbols is I_{CP}; when n = 2, a cyclic shift value corresponding to the 2^{nd} second time domain symbol in the N second time domain symbols is 2*I_{CP}; ...; when n = N – 1, a cyclic shift value corresponding to the (N–1)^{th} second time domain symbol in the N second time domain symbols is (N–1)*I_{CP}; and when n = N, a cyclic shift value corresponding to the N^{th} second time domain symbol in the N second time domain symbols is N*I_{CP}.

It is assumed that the sensing signal includes: a sequence s(1), s(2), ..., or s(M), where M is a length of the sensing signal in each time domain symbol, M is a positive integer greater than 1, the cyclically shifted sensing signal in the n^{th} second time domain symbol may include, for example, a sequence s(n*I_{CP}+1), s(n*I_{CP}+2), ..., s(M–1), s(1), s(2), ..., or s(n*I_{CP}). Specifically, for the n^{th} second time domain symbol, a signal transmitted at a starting point of the n^{th} second time domain symbol is s(n*I_{CP}+1). Then, s(n*I_{CP}+1), s(n*I_{CP}+2), ..., and s(M–1) are sequentially mapped to time domain locations in the n^{th} second time domain symbol in chronological order. After s(M–1) is mapped, starting from s(1), s(1), s(2), ..., and s(n*I_{CP}) are sequentially mapped to the corresponding time domain locations in the n^{th} second time domain symbol, thereby completing cyclic shifting. After completing the cyclic shift, a tail part with a length of I_{CP} is added to a head to complete addition of the cyclic prefix.

For example, it is assumed that the sensing signal includes a sequence (1, 2, 3, 4), the OFDM symbol 1, the OFDM symbol 2, the OFDM symbol 3, and the OFDM symbol 4 that are consecutive are used for repeatedly transmitting the sensing signals, and a periodicity of the sensing signal needs to be ensured. First, a tail of the sequence (1, 2, 3, 4) is added to a head of the OFDM symbol 1 as a cyclic prefix, where a length of the cyclic prefix I

_{CP} = 2, to obtain a sequence of the OFDM symbol 1 that is (3, 4, 1, 2, 3, 4). Second, the sensing signal (1, 2, 3, 4) in the OFDM symbol 2 is cyclically shifted. Herein, N = 3, and the OFDM symbol 2 corresponds to n = 1. Therefore, a cyclic shift value corresponding to the sensing signal (1, 2, 3, 4) in the OFDM symbol 2 is 1*I_{CP} = 2, and a sequence that is (3, 4, 1, 2) is obtained. Then, a CP is added to the sequence (3, 4, 1, 2), to obtain a signal in the OFDM symbol 2 that is (1, 2, 3, 4, 1, 2). Then, the sensing signal (1, 2, 3, 4) in the OFDM symbol 3 is cyclically shifted, and the OFDM symbol 3 corresponds to n = 2. Therefore, a cyclic shift value corresponding to the sensing signal (1, 2, 3, 4) in the OFDM symbol 3 is 2*I_{CP} = 2 * 2 = 4, and a sequence that is (1, 2, 3, 4) is obtained. Then, a CP is added to the sequence (1, 2, 3, 4), to obtain a signal in the OFDM symbol 3 that is (3, 4, 1, 2, 3, 4). Finally, the sensing signal (1, 2, 3, 4) in the OFDM symbol 4 is cyclically shifted, and the OFDM symbol 4 corresponds to n = 3. Therefore, a cyclic shift value corresponding to the sensing signal (1, 2, 3, 4) in the OFDM symbol 4 is 3*I_{CP} = 3 * 2 = 6, and a sequence that is (3, 4, 1, 2) is obtained. Then, a CP is added to the sequence (3, 4, 1, 2), to obtain a signal in the OFDM symbol 4 that is (1, 2, 3, 4, 1, 2). In this way, a signal transmitted on the OFDM symbol 1, the OFDM symbol 2, and the OFDM symbol 3 that are consecutive includes (3, 4, 1, 2, 3, 4, 1, 2, 3, 4, 1, 2, 3, 4, 1, 2, 3, 4, 1, 2, 3, 4, 1, 2). The sequence is periodic, and has a period equal to a length of the sequence (3, 4, 1, 2).

For another example, it is assumed that the sensing signal includes a sequence (1, 2, 3, 4, 5, 6), the OFDM symbol 1, the OFDM symbol 2, and the OFDM symbol 3 that are consecutive are used for repeatedly transmitting the sensing signals, and a periodicity of the sensing signal needs to be ensured. First, a tail of the sequence (1, 2, 3, 4, 5, 6) is added to a head of the OFDM symbol 1 as a CP, where a length of the cyclic prefix I_{CP} = 2, to obtain a sequence of the OFDM symbol 1 that is (5, 6, 1, 2, 3, 4, 5, 6). Second, the sensing signal (1, 2, 3, 4, 5, 6) in the OFDM symbol 2 is cyclically shifted. Herein, N = 2, and the OFDM symbol 2 corresponds to n = 1. Therefore, a cyclic shift value corresponding to the sensing signal (1, 2, 3, 4, 5, 6) in the OFDM symbol 2 is 1*I_{CP} = 2, and a sequence that is (3, 4, 5, 6, 1, 2) is obtained. Then, a CP is added to the sequence (3, 4, 5, 6, 1, 2), to obtain a signal in the OFDM symbol 2 that is (1, 2, 3, 4, 5, 6, 1, 2). Finally, the sensing signal (1, 2, 3, 4, 5, 6) in the OFDM symbol 3 is cyclically shifted, and the OFDM symbol 3 corresponds to n = 2. Therefore, a cyclic shift value corresponding to the sensing signal (1, 2, 3, 4, 5, 6) in the OFDM symbol 3 is 2*I_{CP} = 2 * 2 = 4, and a sequence that is (5, 6, 1, 2, 3, 4) is obtained. Then, a CP is added to the sequence (5, 6, 1, 2, 3, 4), to obtain a signal in the OFDM symbol 3 that is (3, 4, 5, 6, 1, 2, 3, 4). In this way, a signal transmitted on the OFDM symbol 1, the OFDM symbol 2, and the OFDM symbol 3 that are consecutive includes (5, 6, 1, 2, 3, 4, 5, 6, 1, 2, 3, 4, 5, 6, 1, 2, 3, 4, 5, 6, 1, 2, 3, 4). The sequence is periodic, and has a period equal to a length of the sequence (5, 6, 1, 2, 3, 4).

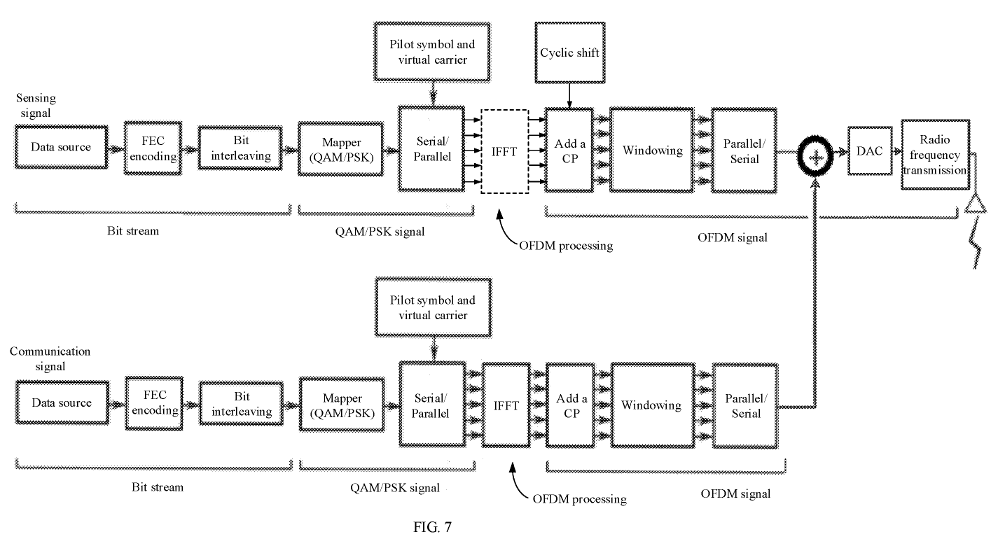

As an example, FIG. 7 shows an OFDM procedure corresponding to Implementation 2, where in the step of adding the cyclic prefix, different processing manners are used for the communication signals and the sensing signals. On a branch corresponding to the sensing signal shown in FIG. 7, it is required to cyclically shift the sensing signal in an OFDM symbol located after the first OFDM symbol, and then add a CP to the cyclically shifted sensing signal. On a branch corresponding to the communication signal shown in FIG. 7, a cyclic prefix may be added in a conventional manner. Finally, the communication signal and the sensing signal may be transmitted simultaneously on the same OFDM symbol, for example, the sensing signal and the communication signal may be transmitted on different subcarriers in the same OFDM signal.

In some implementations, before at least one the cyclic prefix or the cyclic postfix is determined based on the sensing signal, OFDM processing has been performed on the sensing signal, or the OFDM processing has not been performed on the sensing signal. That is, the OFDM processing is optional for the sensing signal. For example, as shown in FIG. 6 and FIG. 7, for the sensing signal, the step of performing IFFT processing may be performed or may not be performed.

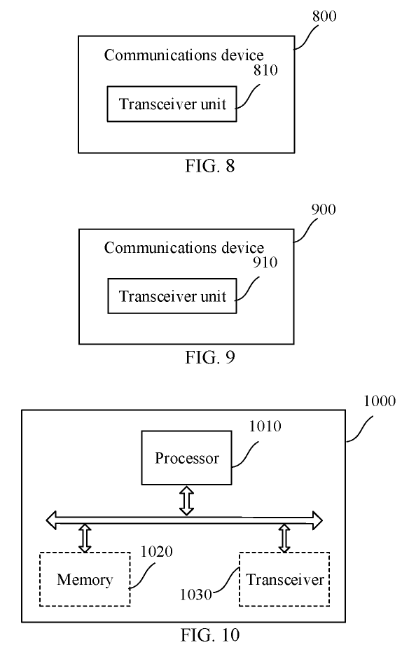

The method embodiments of the present application are described in detail above with reference to FIG. 1 to FIG. 7. Apparatus embodiments of the present application are described in detail below with reference to FIG. 8 to FIG. 10. It should be understood that the description of the method embodiments corresponds to the description of the apparatus embodiments, and therefore, for a part that is not described in detail, reference may be made to the foregoing method embodiments.

FIG. 8 is a schematic structural diagram of a communications device according to an embodiment of the present application. A communications device 800 shown in FIG. 8 may include a transceiver unit 810. The transceiver unit 810 is configured to transmit sensing signals on a plurality of consecutive time domain symbols, where the plurality of time domain symbols include a first time domain symbol and N second time domain symbols located after the first time domain symbol, a signal in the second time domain symbol includes the sensing signal, and a cyclic prefix and/or a cyclic postfix determined based on the sensing signal, signals in the plurality of time domain symbols are periodic and have a period equal to a length of the sensing signal in each time domain symbol, and N is a positive integer.

In some implementations, the cyclic postfix is formed by copying a header signal of the sensing signal to a tail of the sensing signal.

In some implementations, the signal in the second time domain symbol includes: the sensing signal, and the cyclic postfix determined based on the sensing signal; or the cyclically shifted sensing signal and the cyclic prefix that is determined based on the cyclically shifted sensing signal.

In some implementations, when N = 1, the signal in the second time domain symbol includes the sensing signal and the cyclic postfix that is determined based on the sensing signal.

In some implementations, when N > 1, the signal in the second time domain symbol includes the cyclically shifted sensing signal and the cyclic prefix that is determined based on the cyclically shifted sensing signal.

In some implementations, a cyclic shift value corresponding to an n^{th} second time domain symbol in the N second time domain symbols is n*I_{CP}, I_{CP} is a length of the cyclic prefix, and n ranges from 1 to N.

In some implementations, the sensing signal includes a sequence s(1), s(2), ..., or s(M), M is a positive integer greater than 1, and the cyclically shifted sensing signal in the n^{th} second time domain symbol includes a sequence s(n*I_{CP}+1), s(n*I_{CP}+2), ..., s(M–1), s(1), s(2), ..., or s(n*I_{CP}).

In some implementations, the first time domain symbol includes the sensing signal and the cyclic prefix that is determined based on the sensing signal.

In some implementations, before at least one the cyclic prefix or the cyclic postfix is determined based on the sensing signal, OFDM processing has been performed on the sensing signal, or the OFDM processing has not been performed on the sensing signal.

In some implementations, the transceiver unit 810 is further configured to transmit communication signals on the plurality of time domain symbols, where the communication signals and the sensing signals are located on different subcarriers in the plurality of time domain symbols.

It may be understood that the transceiver unit 810 may be, for example, a transceiver 1030. In addition, optionally, the communications device 800 further includes a processor 1010 and a memory 1020. For details, refer to FIG. 10.

FIG. 9 is a schematic structural diagram of a communications device according to an embodiment of the present application. A communications device 900 shown in FIG. 9 may include a transceiver unit 910. The transceiver unit 910 is configured to receive sensing signals transmitted on a plurality of consecutive time domain symbols, where the plurality of time domain symbols include a first time domain symbol and N second time domain symbols located after the first time domain symbol, a signal in the second time domain symbol includes the sensing signal, and a cyclic prefix and/or a cyclic postfix determined based on the sensing signal, signals in the plurality of time domain symbols are periodic and have a period equal to a length of the sensing signal in each time domain symbol, and N is a positive integer.

In some implementations, the cyclic postfix is formed by copying a header signal of the sensing signal to a tail of the sensing signal.

In some implementations, the signal in the second time domain symbol includes: the sensing signal, and the cyclic postfix determined based on the sensing signal; or the cyclically shifted sensing signal and the cyclic prefix that is determined based on the cyclically shifted sensing signal.

In some implementations, when N = 1, the signal in the second time domain symbol includes the sensing signal and the cyclic postfix that is determined based on the sensing signal.

In some implementations, when N > 1, the signal in the second time domain symbol includes the cyclically shifted sensing signal and the cyclic prefix that is determined based on the cyclically shifted sensing signal.

In some implementations, a cyclic shift value corresponding to an n^{th} second time domain symbol in the N second time domain symbols is n*I_{CP}, I_{CP} is a length of the cyclic prefix, and n ranges from 1 to N.

In some implementations, the sensing signal includes a sequence s(1), s(2), ..., or s(M), M is a positive integer greater than 1, and the cyclically shifted sensing signal in the n^{th} second time domain symbol includes a sequence s(n*I_{CP}+1), s(n*I_{CP}+2), ..., s(M–1), s(1), s(2), ..., or s(n*I_{CP}).

In some implementations, the first time domain symbol includes the sensing signal and the cyclic prefix that is determined based on the sensing signal.

In some implementations, before at least one the cyclic prefix or the cyclic postfix is determined based on the sensing signal, OFDM processing has been performed on the sensing signal, or the OFDM processing has not been performed on the sensing signal.

In some implementations, the transceiver unit 910 is further configured to: receive communication signals transmitted on the plurality of time domain symbols, where the communication signals and the sensing signals are located on different subcarriers in the plurality of time domain symbols.

It may be understood that the transceiver unit 910 may be, for example, a transceiver 1030. In addition, optionally, the communications device 900 further includes a processor 1010 and a memory 1020. For details, refer to FIG. 10.

FIG. 10 is a schematic structural diagram of an apparatus for communication according to an embodiment of the present application. Dashed lines shown in FIG. 10 indicate that the unit or module is optional. An apparatus 1000 may be configured to implement the methods described in the foregoing method embodiments. The apparatus 1000 may be, for example, a chip or a communications device.

The apparatus 1000 may include one or more processors 1010. The processor 1010 may allow the apparatus 1000 to implement the methods described in the foregoing method embodiments. The processor 1010 may be a general-purpose processor or a dedicated processor. For example, the processor 1010 may be a central processing unit (central processing unit, CPU). Alternatively, the processor 1010 may be another general-purpose processor, a digital signal processor (digital signal processor, DSP), an application-specific integrated circuit (application specific integrated circuit, ASIC), a field-programmable gate array (field programmable gate array, FPGA) or another programmable logic device, a discrete gate or transistor logic device, a discrete hardware component, or the like. The general-purpose processor may be a microprocessor, or may be any conventional processor or the like.

The apparatus 1000 may further include one or more memories 1020. The memory 1020 stores a program, and the program may be executed by the processor 1010, so that the processor 1010 performs a method described in the foregoing method embodiments. The memory 1020 may be separate from the processor 1010 or may be integrated into the processor 1010.

The apparatus 1000 may further include a transceiver 1030. The processor 1010 may communicate with another device or chip through the transceiver 1030. For example, the processor 1010 may transmit data to and receive data from another device or chip through the transceiver 1030.

An embodiment of the present application further provides a communications system. The communications system includes the communications devices described above (such as the terminal device and the network device). In some implementations, the system further includes another device that interacts with the communications devices.

An embodiment of the present application further provides a computer-readable storage medium for storing a program. The computer-readable storage medium may be applied to a communications device provided in embodiments of the present application, and the program causes a computer to perform a method performed by the communications device in the embodiments of the present application.

An embodiment of the present application further provides a computer program product. The computer program product includes a program. The computer program product may be applied to a communications device provided in embodiments of the present application, and the program causes a computer to perform a method performed by the communications device in the embodiments of the present application.

An embodiment of the present application further provides a computer program. The computer program may be applied to a communications device provided in embodiments of the present application, and the computer program causes a computer to perform a method performed by the communications device in the embodiments of the present application.

It should be understood that the terms “system” and “network” in embodiments of the present application may be used interchangeably. In addition, the terms used in the present application are merely used to explain the specific embodiments of the present application, and are not intended to limit the present application. The terms “first”, “second”, “third”, “fourth”, and the like in the specification, claims, and drawings of the present application are used to distinguish between different objects, rather than to describe a specific order. In addition, the terms “include” and “have” and any variations thereof are intended to cover a non-exclusive inclusion.

In embodiments of the present application, “indicate” mentioned herein may be a direct indication, or may be an indirect indication, or may mean that there is an association relationship. For example, A indicates B, which may mean that A directly indicates B, for example, B may be obtained by using A; or may mean that A indirectly indicates B, for example, A indicates C, and B may be obtained by using C; or may mean that there is an association relationship between A and B.

In embodiments of the present application, “B corresponding to A” means that B is associated with A, and B may be determined based on A. However, it should be further understood that, determining B based on A does not mean determining B based only on A, but instead, B may be determined based on A and/or other information.

In embodiments of the present application, the term “correspond” may mean that there is a direct or indirect correspondence between the two, or may mean that there is an association relationship between the two, or may mean that there is a relationship such as indicating and being indicated, or configuring and being configured.

In embodiments of the present application, “pre-defined” or “pre-configured” may be implemented by pre-storing corresponding code, tables, or other forms that may be used to indicate related information in communications devices (for example, including a terminal device and a network device), and a specific implementation thereof is not limited in the present application. For example, being pre-defined may refer to being defined in a protocol.

In embodiments of the present application, the “protocol” may refer to a standard protocol in the communications field, and may include, for example, an LTE protocol, an NR protocol, and a related protocol applied to a future communications system, which is not limited in the present application.

In embodiments of the present application, the term “and/or” is merely an association relationship that describes associated objects, and represents that there may be three relationships. For example, A and/or B may represent three cases: Only A exists, both A and B exist, and only B exists. In addition, the character “/” in this specification generally indicates an “or” relationship between the associated objects.

In embodiments of the present application, sequence numbers of the foregoing processes do not mean execution sequences. The execution sequences of the processes should be determined according to functions and internal logic of the processes, and should not be construed as any limitation on the implementation processes of embodiments of the present application.

In several embodiments provided in the present application, it should be understood that, the disclosed system, apparatus, and method may be implemented in other manners. For example, the foregoing described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. Indirect couplings or communication connections between apparatuses or units may be implemented in electrical, mechanical, or other forms.

The units described as separate parts may be or may not be physically separate, and parts displayed as units may be or may not be physical units, and may be at one location, or may be distributed on a plurality of network elements. Some or all of the units may be selected according to actual requirements to achieve the objectives of the solutions of embodiments.

In addition, functional units in embodiments of the present application may be integrated into one processing unit, or each of the units may exist alone physically, or two or more units may be integrated into one unit.

All or some of the foregoing embodiments may be implemented by using software, hardware, firmware, or any combination thereof. When the software is used to implement embodiments, all or some of the embodiments may be implemented in a form of a computer program product. The computer program product includes one or more computer instructions. When the computer program instructions are loaded and executed on a computer, the procedures or functions according to embodiments of the present application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from one website, computer, server, or data center to another website, computer, server, or data center in a wired (such as a coaxial cable, an optical fiber, and a digital subscriber line (digital subscriber line, DSL)) manner or a wireless (such as infrared, wireless, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital versatile disc (digital video disc, DVD)), a semiconductor medium (for example, a solid-state drive (solid state disk, SSD)), or the like.

The foregoing descriptions are merely specific implementations of the present application, but the protection scope of the present application is not limited thereto. Any variation or replacement readily figured out by a person skilled in the art within the technical scope disclosed in the present application shall fall within the protection scope of the present application. Therefore, the protection scope of the present application shall be subject to the protection scope of the claims.

What is claimed is:

1. A wireless communication method, comprising:
transmitting sensing signals on a plurality of consecutive time domain symbols, wherein the plurality of time domain symbols comprise a first time domain symbol and N second time domain symbols located after the first time domain symbol, a signal in the second time domain symbol comprises the sensing signal, and at least one of a cyclic prefix determined based on the sensing signal or a cyclic postfix determined based on the sensing signal, signals in the plurality of time domain symbols are periodic and have a period equal to a length of the sensing signal in each time domain symbol, and N is a positive integer.

2. The method according to claim 1, wherein the cyclic postfix is formed by copying a header signal of the sensing signal to a tail of the sensing signal.

3. The method according to claim 1, wherein the signal in the second time domain symbol comprises:
the sensing signal, and the cyclic postfix determined based on the sensing signal; or
the cyclically shifted sensing signal and the cyclic prefix that is determined based on the cyclically shifted sensing signal.

4. The method according to claim 3, wherein when N = 1, the signal in the second time domain symbol comprises the sensing signal and the cyclic postfix that is determined based on the sensing signal.

5. The method according to claim 3, wherein when N > 1, the signal in the second time domain symbol comprises the cyclically shifted sensing signal and the cyclic prefix that is determined based on the cyclically shifted sensing signal.

6. The method according to claim 5, wherein a cyclic shift value corresponding to an n^{th} second time domain symbol in the N second time domain symbols is n*I_{CP}, I_{CP} is a length of the cyclic prefix, and n is an integer that ranges from 1 to N.

7. The method according to claim 6, wherein the sensing signal comprises a sequence s(1), s(2), ..., or s(M), M is a positive integer greater than 1, and the cyclically shifted sensing signal in the n^{th} second time domain symbol comprises a sequence s(n*I_{CP}+1), s(n*I_{CP}+2), ..., s(M–1), s(1), s(2), ..., or s(n*I_{CP}).

8. The method according to claim 3, wherein the first time domain symbol comprises the sensing signal and the cyclic prefix that is determined based on the sensing signal.

9. The method according to claim 1, wherein before at least one the cyclic prefix or the cyclic postfix is determined based on the sensing signal, orthogonal frequency division multiplexing (OFDM) processing has been performed on the sensing signal, or the OFDM processing has not been performed on the sensing signal.

10. The method according to claim 1, wherein the method further comprises:
transmitting communication signals on the plurality of time domain symbols, wherein the communication signals and the sensing signals are located on different subcarriers in the plurality of time domain symbols.

11. A wireless communication method, comprising:
receiving sensing signals transmitted on a plurality of consecutive time domain symbols, wherein the plurality of time domain symbols comprise a first time domain symbol and N second time domain symbols located after the first time domain symbol, a signal in the second time domain symbol comprises the sensing signal, and at least one of a cyclic prefix determined based on the sensing signal or a cyclic postfix determined based on the sensing signal, signals in the plurality of time domain symbols are periodic and have a period equal to a length of the sensing signal in each time domain symbol, and N is a positive integer.

12. The method according to claim 11, wherein the cyclic postfix is formed by copying a header signal of the sensing signal to a tail of the sensing signal.

13. The method according to claim 11, wherein the signal in the second time domain symbol comprises:
the sensing signal, and the cyclic postfix determined based on the sensing signal; or
the cyclically shifted sensing signal and the cyclic prefix that is determined based on the cyclically shifted sensing signal.

14. The method according to claim 13, wherein when N = 1, the signal in the second time domain symbol comprises the sensing signal and the cyclic postfix that is determined based on the sensing signal.

15. The method according to claim 13, wherein when N > 1, the signal in the second time domain symbol comprises the cyclically shifted sensing signal and the cyclic prefix that is determined based on the cyclically shifted sensing signal.

16. The method according to claim 15, wherein a cyclic shift value corresponding to an n^{th} second time domain symbol in the N second time domain symbols is n*I_{CP}, I_{CP} is a length of the cyclic prefix, and n is an integer that ranges from 1 to N.

17. The method according to claim 16, wherein the sensing signal comprises a sequence s(1), s(2), ..., or s(M), M is a positive integer greater than 1, and the cyclically shifted sensing signal in the n^{th} second time domain symbol comprises a sequence s(n*I_{CP}+1), s(n*I_{CP}+2), ..., s(M–1), s(1), s(2), ..., or s(n*I_{CP}).

18. The method according to claim 13, wherein the first time domain symbol comprises the sensing signal and the cyclic prefix that is determined based on the sensing signal.

19. The method according to claim 11, wherein before at least one the cyclic prefix or the cyclic postfix is determined based on the sensing signal, orthogonal frequency division multiplexing (OFDM) processing has been performed on the sensing signal, or the OFDM processing has not been performed on the sensing signal.

20. The method according to claim 11, wherein the method further comprises:
receiving communication signals on the plurality of time domain symbols, wherein the communication signals and the sensing signals are located on different subcarriers in the plurality of time domain symbols.
